(19) United States
(12) Patent Application Publication
(10) Pub. No.: US 2021/0387225 A1
(43) Pub. Date: Dec. 16, 2021

(54) MODULAR FLUID APPLICATION DEVICE FOR VARYING FLUID COAT WEIGHT

(71) Applicant: Illinois Tool Works Inc., Glenview, IL (US)

(72) Inventor: Christopher Scott Rank Graff, Nashville, TN (US)

(21) Appl. No.: 17/284,839

(22) PCT Filed: Nov. 7, 2019
(86) PCT No.: PCT/US19/60297

§ 371 Date: Apr. 13, 2021

Related U.S. Application Data
(60) Provisional application No. 62/758,078, filed on Nov. 9, 2018.

(51) Int. Cl. B05C 11/10; B05B 15/40; B05C 5/02

(52) U.S. Cl. CPC B05C 11/1036; B05B 15/40; B05C 11/1042; B05C 5/0279; B05C 11/1028; B05C 5/0241

(57) ABSTRACT

A modular fluid application device (10) includes a module base (12) and first and second fluid passageways extending within the module base and intersecting to form a nozzle fluid supply passageway. The modular fluid application device also includes a fluid outlet (22) formed on a nozzle mounting surface (24) of the module base fluidically connected to the nozzle fluid supply passageway, a base air passageway extending in the module base and an air outlet formed on the nozzle mounting surface fluidically connected to the base air passageway. A first module bank (14) is removably mounted on the module base and includes at least one first module having a first valve configured to control a flow of fluid in the first fluid passageway. A second module bank (18) is removably mounted on the module base and includes at least one second module having a second valve configured to control a flow of fluid in the second fluid passageway. The first module and the second module are mounted at an angle relative to one another.

### BACKGROUND

Known fluid application devices are used in the manufacture of various articles including disposable hygiene products. In general, the known fluid application devices are configured to discharge hot melt adhesive onto a component of the disposable hygiene product, such as a shell layer or strands of elasticated material. The elasticated material may be used, for example, in leg elastics, waist elastics and cuff elastics of the disposable hygiene product.

The known fluid application devices are constructed differently depending on a particular application, for example, contact or non-contact strand coating, spray, or slot die coating applications. For example, the known fluid application devices require different nozzle types or configurations for certain applications. In addition, some applications require air to be discharged from the nozzle to act on the discharged hot melt adhesive, thereby controlling an application pattern of the adhesive, or that air be introduced within the nozzle for discharging the hot melt adhesive from the nozzle as a spray.

Some known fluid application devices are also configured to vary a coat weight of the fluid to be applied on the component. For example, in a fluid application device having a slot die assembly, separate inlet ports and associated passageways and discharge ports may be provided to allow for multiple flows of the hot melt adhesive to be individually controlled. Accordingly, a first coat weight of hot melt adhesive may be applied from one discharge port, and an add-on coat weight may be selectively applied to the first coat weight from a second discharge port.

In a known strand coating application, known fluid application devices include a metering device having a plurality of gear pumps mounted directly on a manifold of an applicator head. The metering device is configured to receive the hot melt adhesive from a remote supply source and meter the hot melt adhesive to individual nozzles, individual nozzle orifices, or individual valve modules to provide different volumes of the hot melt adhesive to the nozzle. However, such a fluid application device does not include preheated air, and thus, may be limited in the number of application patterns that can be produced.

Further, in some known fluid application devices, an application pattern of the hot melt adhesive, for example, a stitch-type pattern (e.g., an on-off-on-off pattern), may be limited by the on-off cycle time of the valve. For example, with an elasticated strand moving at a constant line speed, the minimum distance between hot melt applications on the strand is dependent upon the length of time required for a valve of the module to move from an open position to a closed position, and then return to the open position. In known fluid application devices, the on-off cycle time is around 6 ms. Thus, to reduce a length of hot melt adhesive application and/or gaps between the adhesive when applying the adhesive in a stitch pattern, the line speed of the strand must be reduced, thereby increasing manufacturing time and reducing output.

A manufacturer typically uses different applicator equipment for the various applications above, which may result in high equipment costs, significant amounts of time where equipment is not being utilized, and a reduction in available floor space in a manufacturing facility.

Accordingly, it is desirable to provide a fluid application device that may be configured to selectively provide heated air, allow different fluid coat weights, and interchangeably accept nozzles of different configurations, including slot die assemblies and laminated plate nozzles, for different applications. It is also desirable to reduce on-off cycle time, thereby increasing the number of possible application patterns and/or allowing for increased line speeds.

### SUMMARY

According to one aspect, a modular fluid application device includes a module base and first and second fluid passageways extending within the module base and intersecting to form a nozzle fluid supply passageway. The modular fluid application device also includes a fluid outlet formed on a nozzle mounting surface of the module base fluidically connected to the nozzle fluid supply passageway, a base air passageway extending in the module base and an air outlet formed on the nozzle mounting surface fluidically connected to the base air passageway. A first module bank is removably mounted on the module base and includes at least one first module having a first valve configured to control a flow of fluid in the first fluid passageway. A second module bank is removably mounted on the module base and includes at least one second module having a second valve configured to control a flow of fluid in the second fluid passageway. The first module and the second module are mounted at an angle relative to one another.

The modular fluid application device may further include a filter block removably secured and fluidically connected to the module base. The filter block may include first and second fluid supply inputs and first and second filters fluidically connected to the first and second fluid supply inputs, respectively, such that the first and second filters are configured to receive the fluid from respective first and second fluid supply inputs. The first module may be fluidically connected to the first filter to receive the fluid from the first filter, and the second module may be fluidically connected to the second filter to receive the fluid from the second filter.

The modular fluid application device may further include an air preheater removably secured and fluidically connected to the module base. The air preheater may include and air supply inlet, one or more heating elements configured to heat air received through the air supply inlet, an air passageway configured to receive the heated air and an air preheater outlet for discharging the air from the air preheater. The one or more heating elements may be spiral heaters. The base air passageway may be fluidically connected to the air preheater to receive air from air preheater.

The modular fluid application device may further include a nozzle removably mounted and fluidically connected to the module base on the nozzle mounting surface. The nozzle may include a front plate, a backing plate and a plurality of laminated nozzle plates secured therebetween. The nozzle may be configured to receive the air and the fluid from the module base.

The first module and the second module may be operable to provide a first operating state in which the first valve is open and the second valve is closed to provide a first volume of fluid to the nozzle, a second operating state in which the first valve is closed and the second valve is open to provide a second volume of fluid to the nozzle, a third operating state in which the first valve is open and the second valve is open to provide a sum of the first volume and the second volume of fluid to the nozzle, and a fourth operating state in which the first valve is closed and the second valve is closed to substantially prevent the fluid from flowing to the nozzle.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a front view of a modular fluid application device according to an embodiment;

FIG. 2 is a side view of the modular fluid application device of FIG. 1;

FIG. 3 is a top view of the modular fluid application device of FIG. 1;

FIG. 4 is a front view of the modular fluid application device of FIG. 1 with nozzles removed, according to an embodiment;

FIG. 5 is a cross-sectional view of the modular fluid application device taken at F-F of FIG. 4, according to an embodiment;

FIG. 6 is a cross-sectional view of the modular fluid application device taken at B-B of FIG. 4, according to an embodiment;

FIG. 7 is an enlarged view of a portion the modular fluid application device taken at detail C of FIG. 4, according to an embodiment;

FIG. 8 is another side view of the modular fluid application device of FIG. 4, according to an embodiment; and

FIG. 9 is a cross-sectional view of the modular fluid application device taken at section E-E of FIG. 8, according to an embodiment.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

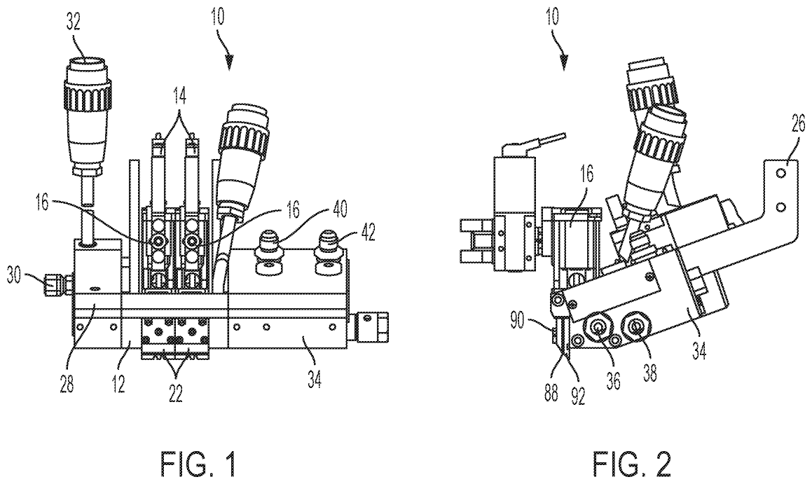

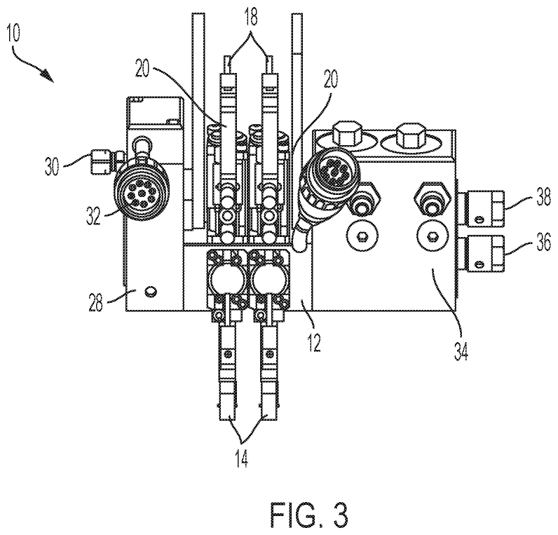

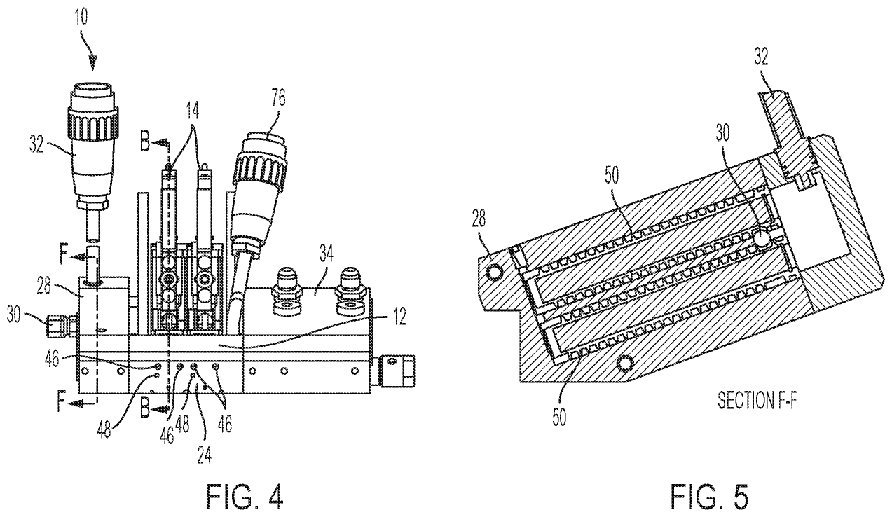

FIG. 1 is a front view of a modular fluid application device 10, according to an embodiment, FIG. 2 is a side view of the modular fluid application device 10 of FIG. 1, and FIG. 3 is a top view of the modular fluid application device 10 of FIG. 1. The modular fluid application device 10 includes a module base 12 and a first module bank 14 removably mounted on the module base 12 having one or more first modules 16. The modular fluid application device 10 also includes a second module bank 18 removably mounted on the module base 12 having one or more second modules 20. One or more nozzles 22 may be releasably secured to a nozzle mounting surface 24 (see FIG. 4) of the module base 12 with a suitable fastener (not shown). A suitable fastener includes, for example, a bolt configured to extend through the nozzle 22 for receipt in a corresponding opening of the module base 12. The modular fluid application device 10 may also include one or more mounting brackets 26 for mounting to a support (not shown). In one embodiment, the modules 16, 20 are fluidically connected to the module base 12.

In one embodiment, the modular fluid application device 10 includes an air preheater 28 removably secured to the module base 12. The air preheater 28 includes an air supply inlet 30 connected to an air supply (not shown). A preheater power connection 32 is configured for connection to a power source (not shown).

In addition, the modular fluid application device 10 may include a filter block 34 removably secured to the module base 12. In one embodiment, the filter block 34 includes a first fluid supply input 36 and a second fluid supply input 38, each configured to receive a fluid, such as a hot melt adhesive, from one or more remotely positioned fluid supplies (not shown). In one embodiment, the first and second fluid inputs 36, 38 may each be connected to the one or more fluid supplies by a flexible supply hose (not shown). In one embodiment, the same fluid is received by the first and second fluid supply inputs 36, 38. Thus, in one embodiment, the fluid may be provided to the modular fluid application 10 as two separate, discrete flows.

The filter block 34 may also include a first filter 40 fluidically connected to the first fluid supply input 36 and configured to receive the fluid from the first fluid supply input 36. The filter block 34 may further include a second filter 42 fluidically connected to the second fluid supply input 38 and configured to receive the fluid from the second fluid supply input 38.

FIG. 4 is another front view of the modular fluid application device 10, according to an embodiment, with the nozzle(s) 22 removed from the nozzle mounting surface 24. As can be seen in FIG. 4, the nozzle mounting surface 24 is formed with one or more fluid outlets 46 through which the fluid may be discharged from the module base 12 for receipt in corresponding nozzle inlets (not shown) of the one or more nozzles 22. The nozzle mounting surface 24 may further be formed with one or more air outlets 48 though which air may be discharged from the module base 12 for receipt in corresponding nozzle air inlets (not shown) of the one or more nozzles 22. In this manner, a nozzle 22 of the one or more nozzles may be fluidically connected to the module base 12 to receive the fluid, such as a hot melt adhesive, and air, such as the preheated air, from the module base 12.

FIG. 5 is a cross-sectional view taken at F-F in FIG. 4, showing a cross section of the air preheater 28. In one embodiment, the air preheater 28 may include one or more heating elements 50 configured to preheat air received in the air preheater 28 via the air supply inlet 30. The one or more heating elements 50 may be, for example spiral heating elements. The heating elements 50 may be powered by way of the power connection 32.

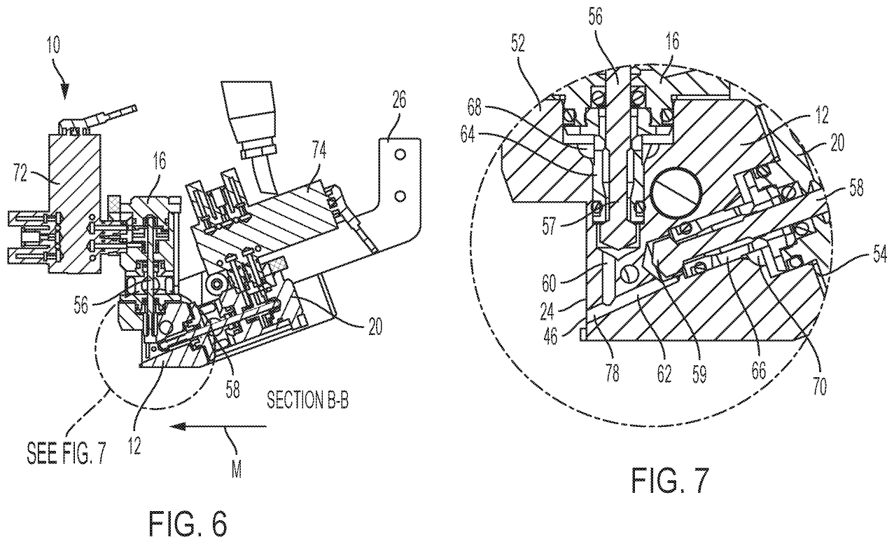

FIG. 6 is a cross-sectional view of the modular fluid application device 10 taken at B-B in FIG. 4, and FIG. 7 is an enlarged view showing a portion of the modular fluid application device 10, taken at detail C in FIG. 6. In one embodiment, a first module 16 of the first module bank 14 and a second module 20 of the second module bank 18 may be removably mounted on the module base 12 at an angle relative to one another with respect to a machine direction ‘M’ for example, to extend in a non-parallel relationship. Accordingly, the module base 12 may include first and second seats 52, 54 to which the first and second modules 16, 20 are mounted.

The first and second modules 16, 20 may be formed as respective valve modules each including a valve 56, 58 having a valve plug 57, 59 movable between a closed position where fluid flow is restricted or prohibited through the respective first and second fluid passageways 60, 62 and an open position where fluid flow is permitted through the respective first and second fluid passageways 60, 62. In addition, each of the first and second modules 16, 20 either include or form in combination with a portion of the module base 12, first and second inlet chambers 64, 66 in fluid communication with the filter block 34. The first and second inlet chambers 64, 66 are configured to receive the fluid from the first and second filters 40, 42, respectively. In one embodiment, the first inlet chamber 64 is fluidically connected to the first filter 40 by a first module supply passageway 68 and the second inlet chamber 66 is fluidically connected to the second filter 42 by a second module supply passageway 70.

In one embodiment, the first and second modules 16, 20 may include respective first and second solenoids 72, 74 for actuating the valves 56, 58. For example, in one embodiment, the first and second solenoids 72, 74 may be operated to allow for control air to pressurize the modules 16, 20 and move the valves 56, 58, for example, the valve plugs 57, 59 from the closed position to the open position and, in some embodiments, maintain the valves 56, 58 in the open position. Conversely, the solenoids 72, 74 may be operated to allow for control air to pressurize the modules 16, 20 to move the valve 56, 58 and plugs 57, 59 from the open position to the closed position. In one embodiment, the valves 56, 58 may be moved against a biasing force from respective biasing members, such as coil springs, which may hold the valve 56, 58 and plugs 57, 59 in a normally closed or open position as desired. Power may be supplied to the solenoids 72, 74 by a module power connection 76 (FIG. 4).

The first and second fluid passageways 60, 62 may extend in one or both a respective module 16, 20 and the module base 12. In one embodiment, the first and second fluid passageways 60, 62 intersect downstream from the first and second valve modules 16, 20 to form one or more nozzle fluid supply passageways 78. The nozzle fluid supply passageway(s) 78 fluidically connected to a corresponding fluid outlet 46 on the nozzle mounting surface 24. In one embodiment, each valve module 16, 20 may control fluid flow to two nozzle fluid supply passageways 78.

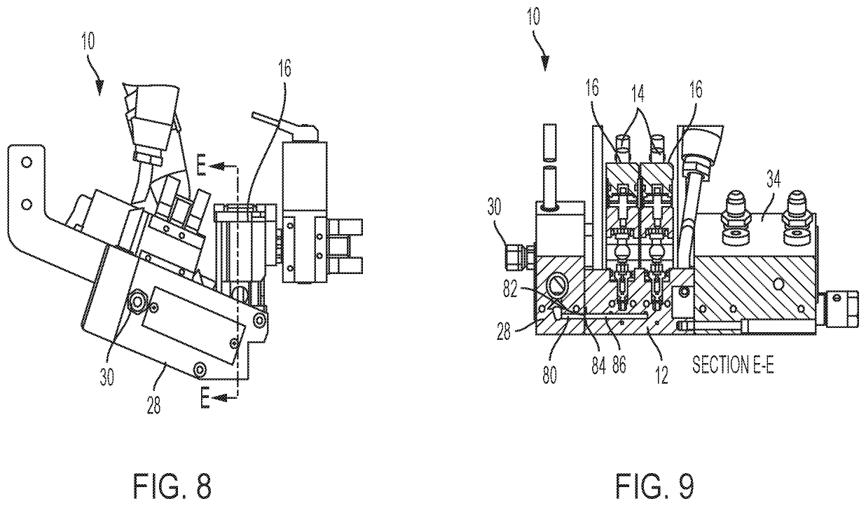

FIG. 8 is another side view of the modular fluid application device 10 according to an embodiment, and FIG. 9 is a cross-sectional view of the modular fluid application device 10 taken at E-E in FIG. 8, according to an embodiment. In one embodiment, the air preheater 28 is fluidically connected to the module base 12 such that the preheated air may be received in the module base 12 from the air preheater 28. For example, in one embodiment, the air preheater 28 includes an air passageway 80 extending between the one or more heating elements 50 and an air preheater outlet 82 on a surface of the air preheater 28. The module base 12 may include a base air inlet 84 positioned relative to the air preheater outlet 82 to receive the air from the air preheater 28. A base air passageway 86 extends in the module base 12 from the base air inlet 84 to one or more air outlets 48 on the nozzle mounting surface 24 (FIG. 4). The one or more air outlets 48 are fluidically connected to the base air passageway 86 so that the air may be discharged from the one or more air outlets 46 for receipt in the nozzle 22.

According to the embodiments herein, the first module 16 and the second module 20 may be operated by moving the valves 56, 58 between open and closed positions to provide respective volumes (i.e. volume flow rates) of the fluid to the one or more nozzles 22. In one embodiment, the volume of the fluid provided to the nozzle 22 by each module 16, 20 is dependent upon a volume flow rate of the fluid provided to the module from first and/or second metering devices (not shown), which may be positioned remotely and upstream from the filter block 34. In one embodiment, the first metering device may provide the fluid to the first module 16, via the filter block 34 and first filter 40, at a first volume, and the second metering device may provide the fluid to the second module 20, via the filter block 34 and second filter 42, at a second volume. The first volume and the second volume may be controlled by the metering devices, and may be equal to, or different from one another. Accordingly, the first module 16 and the second module 20 may provide equal or different volumes of the fluid to the nozzle 22 depending on a desired application.

In the manner above, different operating states in which different volumes (i.e., volume flow rates) of the fluid are discharged from the nozzle 22 may be realized. For example, in a first operating state, the first module 16 may be open and the second module 20 may be closed to provide the first volume of the fluid to the nozzle 22. In a second operating state, the first module 16 maybe closed and the second module 20 may be open to provide the second volume of fluid to the nozzle 22. In a third operating state, the first module 16 and the second module 20 may both be open to provide the sum of the first volume and the second volume of fluid to the nozzle 22. In a fourth operating state, the first module 16 and the second module 20 may both be closed to substantially prevent the fluid from being delivered to the nozzle 22. In one embodiment, the modular fluid application device 10 may switch between operating states in a predetermined manner to discharge the fluid at a desired coat weight and/or stitch pattern. Fluid provided to the nozzle may be discharged for application onto a substrate, such as a strand or layer of material, substantially according to the volume at which the fluid was provided to the nozzle.

Referring again to FIGS. 1 and 2, in one embodiment, the nozzle 22 may be a laminated plate (LP) nozzle comprising a plurality of nozzle plates 88 secured between a face plate 90 and a backing plate 92. The nozzle 22 is configured to receive the fluid and the air from the module base 12 through the backing plate and direct the fluid and air through nozzle 22 for discharge and application on a strand of material. In one embodiment, the air is discharged in a manner which causes the fluid to oscillate or vacillate, and in turn, to be applied on the strand in a non-linear pattern.

However, the present disclosure is not limited to the nozzle 22 described above and shown in FIG. 1. For example, in one embodiment, the nozzle may be a spray nozzle in which the air and fluid are supplied to a common channel thereby causing the fluid to be sprayed in an atomized or droplet form. In some embodiments, the nozzle 22 and/or the plurality nozzle plates 88 may be formed as a unitary structure, instead of a laminated structure, for example, using known machining processes or additive manufacturing.

In one embodiment, the nozzle may be a LP nozzle configured for use in contact strand coating applications which may be performed without supplying air to the nozzle. Thus, in one embodiment, the modular fluid application device 10 may be assembled without the air preheater 28, or operated without supplying preheated air to the nozzle 22, for applications in which preheated air is not used.

In another embodiment, the nozzle may be a slot die assembly configured for substrate coating applications. The slot die assembly may include an adapter, a front plate, and a shim package secured therebetween in a manner which will be appreciated by those having skill in the art. The shim package may include a plurality of shims, one or more of which may include a discharge slot for discharging the fluid. Such a slot die assembly does not require preheated air. Accordingly, the modular fluid application device 10 may be assembled without the air preheater 28, or operated without supplying preheated air to the nozzle 22, for this application as well.

In the embodiments above, different fluid coat weights may be provided in the first, second, third and fourth operation states. However, in an embodiment where different fluid coat weights are not desired, the filter block 34 may be replaced with a conventional single inlet filter block (not shown) configured to receive a single supply or flow of fluid at a predetermined flow rate and provide the single supply of fluid to a module for controlling flow of the fluid to the nozzle 22. Alternatively, the filter block 34 described herein may be used while receiving a fluid flow into only one of the fluid inputs 36, 38, and/or maintaining one valve 56, 58 in the closed condition while operating the other valve 56, 58 to control the single flow of fluid to the nozzle 22.

According to an embodiment described herein, the fluid may be received in the filter block 34 as at least two separate and discrete flows through the first and second supply inputs 36, 38. The fluid may be maintained as separate and discrete flows through the filter block 34, the first and second modules 16, 20 and into the module 12. In one embodiment, the separate flows of the fluid may be combined in the nozzle fluid supply passageway 78 or controlled to flow alternately in the nozzle fluid supply passageway 78 based on operation of the valves 56, 58 in the first and second modules 16, 20. In another embodiment, the single fluid flow may be provided to the modular fluid application device 10 and be split into two or more fluid flows by way of a manifold (not shown).

Moreover, in the embodiments above, the first and second modules 16, 20 may be operated to reduce an on-off cycle time compared to a conventional fluid application device in which a single module controls fluid flow to a nozzle. For example, in the embodiments above, the first and second modules 16, 20 may be operated simultaneously such that one of the modules 16, 20 may be moving to the open position while the other of the modules 16, 20 is moving to the closed position, thereby reducing the length of a time period in which fluid is not provided to the nozzle 22. Accordingly, in one embodiment, a line speed of a substrate, such as an elasticated strand, may be increased compared a line speed of the same in a conventional single module fluid application device, while maintaining or reducing a length of a stitch application pattern (e.g., an on-off-on-off . . . application pattern). Moreover, the modular fluid application device 10 described herein may be operated to apply the fluid on a substrate, such as a strand or layer of material, at a variety of different coat weights without modifying the construction modular fluid application device 10. Rather, the coat weights may be modified by operating the first and second modules 16, 20, while maintaining the ability to operate at the reduced on-off cycle times.

In one embodiment, the first and second modules 16, 20 may be operably connected to a controller configured to control operation of the valves 56, 58, for example, by operating the solenoids 72, 74. The controller may include a processor, such as a microprocessor, and a memory configured to store program instructions relating to the operation of the modules 16, 20. The processor may execute the program instructions and control operation of the valves 56, 58 and the solenoids 72, 74 according to the program instructions. The controller may also include an input/output unit configured to allow for information, signals, instructions, communications and the like to be received by and/or transmitted from the controller.

The modular fluid application device 10 described in the embodiments above may be used to apply a fluid, such as a hot melt adhesive, onto a strand of material (including elasticated strands) or a layer of material, such as a barrier or shell layer. Such an application may be useful in the manufacture of nonwoven products including disposable hygiene products. However, the present disclosure is not limited thereto. It is understood that the fluid application device described herein may be used in other applications as well, for example, packaging.

In the embodiments above, various features from one embodiment may be implemented in, used together with, or replace other features in different embodiments as suitable.

All patents referred to herein, are hereby incorporated herein in their entirety, by reference, whether or not specifically indicated as such within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A modular fluid application device comprising:
a module base;
a first fluid passageway extending within the module base;
a second fluid passageway extending within the module base and intersecting the first fluid passageway to form a nozzle fluid supply passageway downstream from the first and second fluid passageways;
a fluid outlet formed on a nozzle mounting surface of the module base and fluidically connected to the nozzle fluid supply passageway;
a base air passageway extending in the module base;
an air outlet formed on the nozzle mounting surface and fluidically connected to the base air passageway;
a first module bank removably mounted on the module base, the first module bank comprising at least one first module having a first valve configured to control a flow of fluid in the first fluid passageway; and
a second module bank removably mounted on the module base, the second module bank comprising at least one second module having a second valve configured to control a flow of fluid in the second fluid passageway,
wherein the first module and the second module are mounted at an angle relative to one another.

2. The modular fluid application device of claim 1, further comprising a filter block removably secured and fluidically connected to the module base.

3. The modular fluid application device of claim 2, wherein the filter block comprises first and second fluid supply inputs and first and second filters fluidically connected to the first and second fluid supply inputs, respectively, such that the first and second filters are configured to receive the fluid from respective first and second fluid supply inputs.

4. The modular fluid application device of claim 3, wherein the first module is fluidically connected to the first filter and is configured to receive the fluid from the first filter, and the second module is fluidically connected to the second filter and is configured to receive the fluid from the second filter.

5. The modular fluid application device of claim 1, further comprising an air preheater removably secured and fluidically connected to the module base.

6. The modular fluid application device of claim 5, wherein the air preheater comprises and air supply inlet, one or more heating elements disposed within the air preheater configured to heat air received through the air supply inlet, an air passageway configured to receive the heated air and an air preheater outlet for discharging the air from the air preheater.

7. The modular fluid application device of claim 6, wherein the one or more heating element is a spiral heater.

8. The modular fluid application device of claim 6, wherein the base air passageway is fluidically connected to the air preheater and is configured to receive air from air preheater.

9. The modular fluid application device of claim 1, further comprising a nozzle removably mounted and fluidically connected to the module base on the nozzle mounting surface.

10. The modular fluid application device of claim 9, wherein the nozzle comprises a front plate, a backing plate and a plurality of laminated nozzle plates secured therebetween.

11. The modular fluid application device of claim 10, wherein the nozzle is configured to receive the air and the fluid from the module base.

12. The modular fluid application device of claim 9, wherein the first module and the second module are operable to provide:
a first operating state in which the first valve is open and the second valve is closed to provide a first volume of fluid to the nozzle;
a second operating state in which the first valve is closed and the second valve is open to provide a second volume of fluid to the nozzle;
a third operating state in which the first valve is open and the second valve is open to provide a sum of the first volume and the second volume of fluid to the nozzle; and
a fourth operating state in which the first valve is closed and the second valve is closed to substantially prevent the fluid from flowing to the nozzle.
